(19) United States
(12) Patent Application Publication
(10) Pub. No.: US 2010/0177239 A1
(43) Pub. Date: Jul. 15, 2010

(54) METHOD OF AND APPARATUS FOR FRAME RATE CONVERSION

(76) Inventors: Marc Paul Servais, Oxford (GB); Lyndon Hill, Oxford (GB); Toshio Nomura, Oxford (GB)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/663,300

(22) PCT Filed: May 28, 2008
(86) PCT No.: PCT/JP2008/060241

§ 371 Date: Dec. 7, 2009

(30) Foreign Application Priority Data
Jun. 13, 2007 (GB) 0711390.5

(51) Int. Cl. H04N 7/01

(52) U.S. Cl. 348/441; 348/E07.003

(57) ABSTRACT

A method is provided for performing robust frame rate conversion of video data to a higher frame rate. A metric is formed (16) as a function of motion compensation error normalised by a measure of image content, such as image texture (10, 11). The metric is then compared with thresholds (17, 18) to determine whether conversion will be based on motion compensated interpolation or frame repetition. If the metric falls between thresholds, the previously selected mode may be repeated.

### TECHNICAL FIELD

The present invention relates to methods of and apparatuses for performing frame rate conversion (FRC) of video.

FRC is useful for reducing motion blur and judder artefacts that can occur when fast motion is present within a scene. Motion Compensated Frame Interpolation (MCFI) is used to achieve FRC by interpolating new frames in order for viewers to achieve a smoother perception of motion. Applications of FRC include video format conversion and improving visual quality in television displays.

Video has traditionally been captured and displayed at a variety of frame rates, some of the most common of which are outlined below:

Film (movie) material is captured at 24 (progressive) frames per second. In cinemas it is typically projected at 48 or 72 Hz, with each frame being double or triple shuttered in order to reduce flicker.

PAL-based television cameras operate at 25 (interlaced) frames per second, with each frame consisting of two fields—captured one fiftieth of a second apart in time. The field rate is thus 50 Hz. On interlaced displays—such as PAL Cathode Ray Tube (CRT) TVs—PAL signals are shown at their native 50 Hz field rate. On progressive displays (such as Plasma and LCD TVs), de-interlacing is often performed first and the resulting video is then shown at 50 (progressive) frames per second. Note that the above is also true for the SECAM format, which has the same frame rate as PAL.

NTSC-based television cameras operate at 30 (interlaced) frames per second, with each frame consisting of two fields—captured one sixtieth of a second apart in time. The field rate is thus 60 Hz. On interlaced displays (such as NTSC CRT TVs), NTSC signals are shown at their native 60 Hz field rate. On progressive displays (such as Plasma and LCD TVs), de-interlacing is often performed first and the resulting video is then shown at 60 (progressive) frames per second.

HDTV supports a number of frame rates, the most common of which are 24 (progressive), 25 (progressive and interlaced), 30 (progressive and interlaced), 50 (progressive) and 60 (progressive) frames per second.

From the point of view of format conversion, FRC is thus necessary when video with a particular frame rate is to be encoded/broadcast/displayed at a different frame rate.
The human visual system is sensitive to a number of different characteristics when assessing the picture quality of video. These include: spatial resolution, temporal resolution (frame rate), bit depth, colour gamut, ambient lighting, as well as scene characteristics such as texture and the speed of motion.

CRT and Plasma TVs display each field/frame for a very short interval. However, if the refresh rate is too low (less than around 60 Hz, depending on brightness) this can result in the viewer observing an annoying flicker. LCD TVs display each frame for the entire frame period, and therefore flicker is not a problem. However, the “sample and hold” nature of LCDs means that motion blur can be observed when fast motion is displayed at relatively low frame rates.

In addition, the problem of judder can often be observed. This occurs when frames in a sequence appear to be displayed for unequal amounts of time or at the wrong points in time, and often arises when frame repetition is used to achieve FRC.

For example, consider the case of converting a sequence originally at 24 progressive frames per second (24 p) to a rate of 60 progressive frames per second (60 p). A common approach would be to convert the 24 p sequence of frames (A_{1/24}-B_{2/24}-C_{3/24}-D_{4/24}- . . . ) to 60 p using an un-equal 3:2 repetition pattern (A_{1/60}-A_{2/60}-A_{3/60}-B_{4/60}-B_{5/60}-C_{6/60}-C_{7/60}-C_{8/60}-D_{9/60}-D_{10/60}- . . . ). The frame repetition from this type of conversion process would result in judder, thus preventing the portrayal of smooth motion.

As another example, consider the case of converting a 25 p sequence to 50 p—i.e. doubling the frame rate. A common approach would be to convert the 25 p sequence of frames (A_{1/25}-B_{2/25}-C_{3/25}-D_{4/25}- . . . ) to 50 p by simply repeating every frame (A_{1/50}-A_{2/50}-B_{3/50}-B_{4/50}-C_{5/50}-C_{6/50}-D_{7/50}-D_{8/50}- . . . ). A “sample and hold” display would show no obvious difference between the 25 p and 50 p sequences. However, some other displays (where frames are only shown for an instant) would show some judder for the 50 p video. This is because there is no motion between some frames (e.g. B_{3/50}-B_{4/50}), while there is between others (e.g. B_{4/50}-C_{5/50}).

From the point of view of enhancing image quality on a display, performing FRC to higher frame rates (using motion compensated interpolation) is thus necessary to ensure the smoother (and more realistic) portrayal of motion in a scene.

The majority of FRC methods use motion estimation techniques to determine the motion between frames in a sequence. When true motion is estimated accurately, then FRC can be performed effectively.

However, there may be cases in which it is difficult to model motion accurately. For example, when a foreground object moves within a scene, it occludes (covers) part of the background, thus complicating the motion estimation process. Similarly, a change in illumination within a scene may be misinterpreted as motion, thus resulting in the estimated motion vectors being incorrect. Interpolating a new frame using erroneous motion vectors is, in turn, likely to result in an image with noticeable motion compensation artefacts, since some objects may appear to move to unnatural positions.

Consequently, it is necessary to detect failures in the motion estimation and compensation process, and to try and correct for these failures in a reasonable way. By doing so, the FRC process can be made more robust. In certain cases, a human observer may consider motion blur or judder to be less objectionable than using a higher frame rate with some frames showing motion compensation artefacts.

### BACKGROUND ART

De Haan et al developed the Philips “Natural Motion” system [1, 2, 9], which performs FRC using motion compensated interpolation (See FIG. 1 of the accompanying drawings). However, motion estimation is not always reliable due to changes in illumination, complex motion, or very fast motion. When the motion estimation process does fail, De Haan et al propose several ways in which a motion compensated interpolation system is able to “gracefully degrade”:

In one approach, if the motion estimation algorithm does not converge in the time available, or if the motion vector field is insufficiently smooth, then fields/frames are repeated instead of being interpolated [3, 8].

Alternatively, in regions corresponding to motion vectors with large errors, “smearing” (using a weighted sum of candidate pixel values) can be used in order to diminish the visibility of motion compensation errors in the interpolated field/frame [4, 5].

In another approach, if motion vectors are considered to be unreliable (by having a large error value associated with them), then they may be reduced in magnitude in order to try and decrease the resulting motion compensation artefacts [6].

In yet another method, edges in the motion vector field are detected—in order to try and determine regions where motion compensation (using the motion vector field) may lead to artefacts. Image parts are then interpolated with the aid of ordered statistical filtering at edges [7].

Hong et al describe a robust method of FRC in which frames are repeated (rather than interpolated) when the motion estimation search complexity exceeds a given threshold [10].

In an alternative robust approach, Lee and Yang consider the correlation between the motion vector of each block and those of its neighbouring blocks. This correlation value is then used to determine the relative weighting of motion-compensated and blended pixels [11].

Winder and Ribas-Corbera describe a frame synthesis method for achieving FRC in a robust manner. If global motion estimation is deemed sufficiently reliable, and if motion vector variance is relatively low, then frames are interpolated using motion compensation. If not, they are simply repeated. [12].

### REFERENCES

[1] G. de Haan, J. Kettenis, B. Deloore, and A. Loehning, “IC for Motion Compensated 100 Hz TV, with a Smooth Motion Movie-Mode”, IEEE Tr. on Consumer Electronics, vol. 42, no. 2, May 1996, pp. 165-174.
[2] G. de Haan, “IC for motion compensated deinterlacing, noise reduction and picture rate conversion”, IEEE Transactions on Consumer electronics, August 1999, pp 617-624.
[3] G. de Haan, P. W. A. C Biezen, H. Huijgen, and O. A. Ojo, “Graceful Degradation in Motion Compensated Field-Rate Conversion”, in: Signal Processing of HDTV, V, L. Stenger, L. Chiariglione and M. Akgun (Eds.), Elsevier 1994, pp. 249-256.
[4] O. A. Ojo and G. de Haan, “Robust motion-compensated video up-conversion”, in IEEE Transactions on Consumer Electronics, Vol. 43, No. 4, November 1997, pp. 1045-1056.
[5] G. de Haan, P. W. A. C Biezen, H. Huijgen, and O. A. Ojo, U.S. Pat. No. 5,534,946: “Apparatus for performing motion-compensated picture signal interpolation”, July 1996.
[6] G. de Haan and P. W. A. C Biezen, U.S. Pat. No. 5,929,919: “Motion-Compensated Field Rate Conversion”, July 1999.
[7] G. de Haan and A. Pelagotti, U.S. Pat. No. 6,487,313: “Problem Area Location in an Image Signal”, November 2002.
[8] Philips MELZONIC Integrated Circuit (IC) SAA4991, “Video Signal Processor”, http://www-us2.semiconductors.philips.com/news/content/file_{—}152.html
[9] Philips FALCONIC Integrated Circuit (IC) SAA4992, “Field and line rate converter with noise reduction”
[10] Sunkwang Hong, Jae-Hyeung Park, and Brian H. Berkeley, “Motion-Interpolated FRC Algorithm for 120 Hz LCD”, Society for Information Display, International Symposium Digest of Technical Papers, Vol. XXXVII, pp. 1892-1895, June 2006.
[11] S-H Lee and S-J Yang, U.S. Pat. No. 7,075,988: “Apparatus and method of converting frame and/or field rate using adaptive motion compensation”, July 2006.
[12] S. A. J. Winder and J. Ribas-Corbera, US Patent 2004/0252759: “Quality Control in Frame Interpolation with Motion Analysis”, December 2004.
[13] Hang, H., Chou, Y., and Cheng, S. 1997. “Motion Estimation for Video Coding Standards”, J. VLSI Signal Process. Syst. 17, 2-3 (November 1997), 113-136.)

### DISCLOSURE OF INVENTION

According to a first aspect of the invention, there is provided a method of performing frame rate conversion to a higher frame rate, comprising: forming a metric as a function of motion compensation error normalised by a measure of image content; and selecting between a motion compensated interpolation mode and a frame repetition mode in accordance with the value of the metric.

The function may be an increasing function of increasing motion compensation error. The metric may be proportional to an average of the product of the motion compensation error and the absolute value of the motion vector gradient for each of a plurality of image blocks. The metric may be inversely proportional to the measure of image content.

The metric may also be a function of at least one of average speed of motion between frames, maximum speed of motion between frames and maximum absolute value of motion vector spatial gradient. The metric may be inversely proportional to a linear combination of the average speed of motion, the maximum speed of motion and the maximum absolute value of the motion vector gradient.

The frame repetition mode may be selected if the metric is greater than a first threshold. The motion compensated interpolation mode may be selected if the metric is less than a second threshold. The first threshold may be greater than the second threshold and the previously selected mode may be selected if the metric is between the first and second thresholds.

The measure of image content may be a measure of image texture. The measure of image texture may comprise an average absolute value of an image spatial gradient.

According to a second aspect of the invention, there is provided a method of performing frame rate conversion to a higher frame rate, comprising: forming a metric as a function of speed of motion between consecutive frames; and selecting between a motion compensated interpolation mode and a frame repetition mode in accordance with the value of the metric.

The function may be an increasing function of decreasing speed of motion. The metric may be inversely proportional to a linear combination of average speed of motion between frames, maximum speed of motion between frames and maximum absolute value of motion vector spatial gradient.

The frame repetition mode may be selected if the metric is greater than a first threshold. The motion compensated interpolation mode may be selected if the metric is less than a second threshold. The first threshold may be greater than the second threshold and the previously selected mode may be selected if the metric is between the first and second thresholds.

The metric may be inversely proportional to a measure of image content. The measure of image content may be a measure of image texture. The measure of image texture may comprise an average absolute value of an image spatial gradient.

According to a third aspect of the invention, there is provided an apparatus for performing a method according to the first or second aspect of the invention.

It is thus possible to provide a technique for determining when it is preferable to use either motion compensated interpolation or frame repetition in order to perform FRC. In general, motion compensated interpolation is preferable but, as highlighted above, it can result in disturbing artefacts when the motion estimation process produces poor results.

The choice of mode may be determined on the basis of a number of known features. These features include: the motion vectors between the current (original) frame and the previous (original) frame; the corresponding motion compensation error; and the current and previous (original) frames.

The faster the motion within a scene, the greater is the need for motion compensated interpolation. This is because the temporal sampling rate (i.e. the frame rate) may be too slow to describe fast motion—resulting in temporal sampling judder. When this occurs, the viewer is unable to track motion smoothly and tends to perceive individual frames rather than fluid motion.

When performing motion estimation and compensation, the reliability of the interpolation process can be estimated using the motion compensation error. Motion compensation error is the distortion that results when performing motion compensation (from some known frame/s) to interpolate a frame at a specific point in time. Motion compensation error is generally calculated automatically as part of the motion estimation process.

A number of different motion compensation error metrics are used for quantifying image distortion. The most common are probably the Sum (or Mean) of Absolute Differences, and the Sum (or Mean) of Squared Differences. For a given scene, the greater the motion compensation error is, the more likely it is that motion compensation artefacts in the interpolated frame will be objectionable.

Nevertheless, popular motion compensation error metrics such as the Sum of Absolute Differences (SAD) are generally an unreliable guide for the quality of motion compensation across a range of different images. This is because SAD and similar metrics are very sensitive to individual scene characteristics such as image texture and contrast. Thus a reasonable SAD value in one scene can differ significantly from a reasonable SAD value in another scene.

In order to obtain an error metric that provides more consistent results across a range of images, a normalisation process may be based on the texture present within each image. In addition, the motion compensation error may be given a higher weighting in the proximity of motion edges, since motion vectors are generally less reliable along the boundaries of moving objects.

The speed of motion can easily be measured by considering the (already calculated) motion vectors between the current frame and the previous frame.

Consequently, a trade-off may be performed between the speed of motion and the magnitude of the associated motion compensation artefacts, in order to determine an appropriate mode of FRC: either frame repetition or motion compensated interpolation.

Another factor when choosing to perform FRC (using either frame repetition or motion compensation) is to consider the choice for the previous combination of (original) frames. By adding a small amount of hysteresis to the system, unnecessarily frequent switching between different FRC modes may be reduced.

FRC is an important component of video format conversion. One of its primary advantages is that it can help to provide an improved viewing experience by interpolating new frames, thus allowing motion to be portrayed more smoothly. However, if motion is estimated incorrectly, then the interpolated frames are likely to include unnatural motion artefacts.

The present techniques allow for robust FRC by aiming to ensure that an optimal choice is made between frame repetition and motion compensated interpolation. Consequently, they help to prevent undesirable motion compensation artefacts which are sometimes caused by FRC and which may be more disturbing than those arising from the use of a relatively low frame rate.

Some other approaches to robust FRC (such as [6]) may modify only a selection of motion vectors within a frame. However, this can lead to an interpolated frame depicting various parts of a scene at different points in time. While this approach may be preferable to displaying motion compensation artefacts, it can result in annoying temporal artefacts when observing the relative motion of objects over several frames. In contrast, the present techniques portray each frame (whether interpolated or repeated) as a snapshot of a scene at one point in time.

The present techniques require relatively little additional computational overhead to determine the appropriate FRC mode (either interpolation or repetition). This is because they may rely on previously calculated values, such as the motion vectors, their corresponding motion compensation error, and the current image. Nevertheless, some limited additional processing is required to calculate the image gradient and the motion vector gradient. The computational overhead associated with determining the appropriate FRC mode is greater than for methods based on a computational (time) threshold [10], but similar to methods that consider both motion vector smoothness and motion compensation error [12].

Using a normalised motion compensation error metric (which uses the image gradient in the normalisation process) allows for error values to be measured and compared across a range of image types. Traditional error metrics, such as SAD, are also sensitive to the degree of texture present within a scene and can vary widely from one image to another, even though both may have similar motion characteristics.

### BRIEF DESCRIPTION OF DRAWINGS

FIG. 1 illustrates a known method of performing frame rate conversion using motion compensated interpolation;

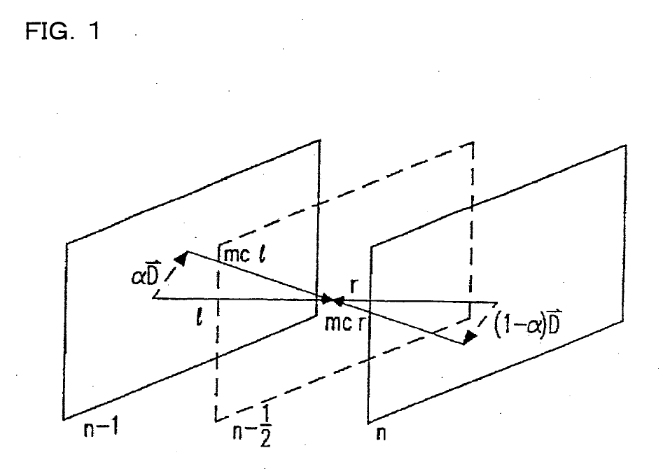

FIG. 2 illustrates a method of performing block-based motion estimation and compensation for frame rate conversion;

FIG. 3 shows how the motion compensation error (associated with a motion vector) can be determined using nearby original frames;

FIG. 4 illustrates a method of performing frame rate conversion constituting an embodiment of the invention;

FIG. 5 illustrates the method of FIG. 4 in more detail; and

FIG. 6 illustrates an example of a device for achieving Robust FRC to increase the frame rate of video for a display.

### BEST MODE FOR CARRYING OUT THE INVENTION

Robust FRC is achieved by selecting the more appropriate of two methods: frame repetition or motion compensated interpolation. In determining the better choice, a number of values computed during the motion estimation process are required. Consequently, this places some restrictions on the method of motion estimation used by the system.

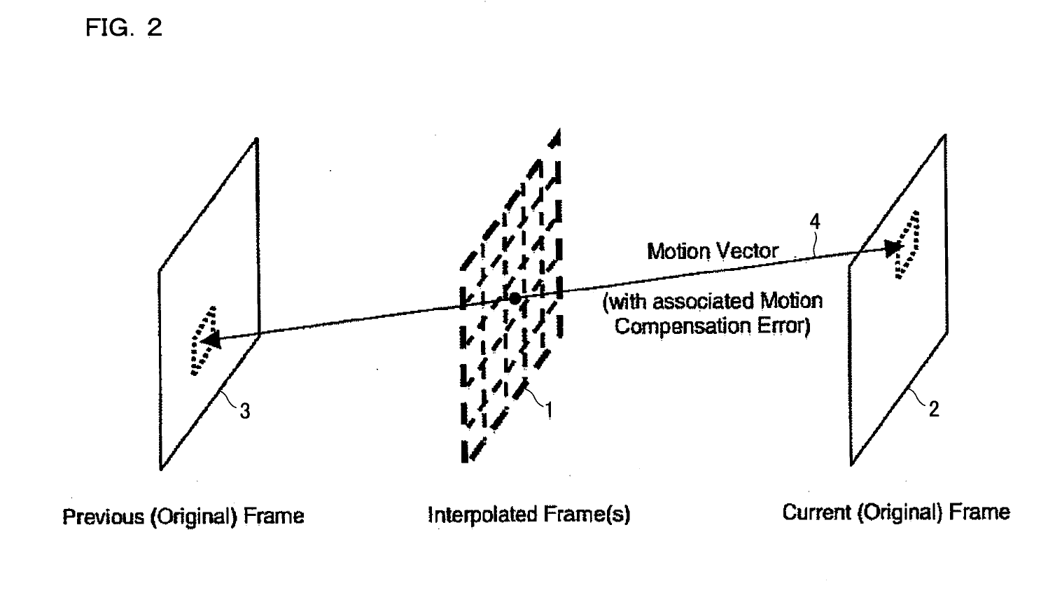

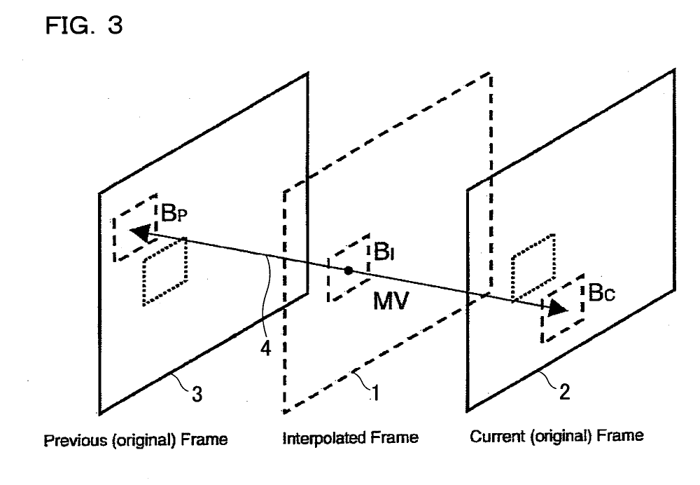

A standard block-based motion estimation process is assumed, as illustrated in FIGS. 2 and 3. Note that other motion estimation methods (e.g. region/object-based, gradient-based, or pixel-based) could also be used. A motion vector field and its corresponding motion compensation error values are required.

Each interpolated frame 1 is positioned in time between two original frames—the current frame 2 and the previous frame 3. Depending on the output frame rate (after FRC), there may be more than one interpolated frame between pairs of original frames.

For block-based motion estimation, each frame that is to be interpolated is divided into regular, non-overlapping blocks during the motion estimation process. For each block in the interpolated frame, the motion estimation process yields a motion vector and a corresponding measure of motion compensation error.

The motion vector 4 for a block indicates the dominant direction and speed of motion within that block and is assumed to have been calculated during a prior block-matching process. Each motion vector pivots about the centre of its block in the interpolated frame—as shown in FIGS. 2 and 3.

Associated with each motion vector is an error measure—which provides an indication of how (un)reliable a motion vector is. When interpolating a new frame for FRC, it is impossible to measure the motion compensation error relative to an original frame at the same point in time, since the original frame does not exist. However, the motion compensation error for each motion vector can be determined by comparing the matching regions in those original frames used during the estimation process.

FIG. 3 shows the position of a block (Br) in the interpolated frame 1, and its motion vector (MV) 4. The motion vector pivots about the centre of its block and points to the centre of a block (B_{P}) in the previous original frame and to the centre of a block (B_{C}) in the current original frame. The error associated with the motion vector is a function of the difference between corresponding pixels in blocks B_{P} and B_{C}.

In general, the motion compensation error for a region is determined directly during the motion estimation process for that region, since the motion estimation process generally seeks to minimise the motion compensation error. The present method uses the Sum of Absolute Differences (SAD) as the error metric, although other choices are possible. In addition, regions need not be restricted to regular blocks but can vary in size and shape from one pixel to the entire frame. The motion compensation error for a region is thus calculated as the sum of the absolute values of the differences between corresponding pixels in the previous frame and a later (current or interpolated according to the context) frame.

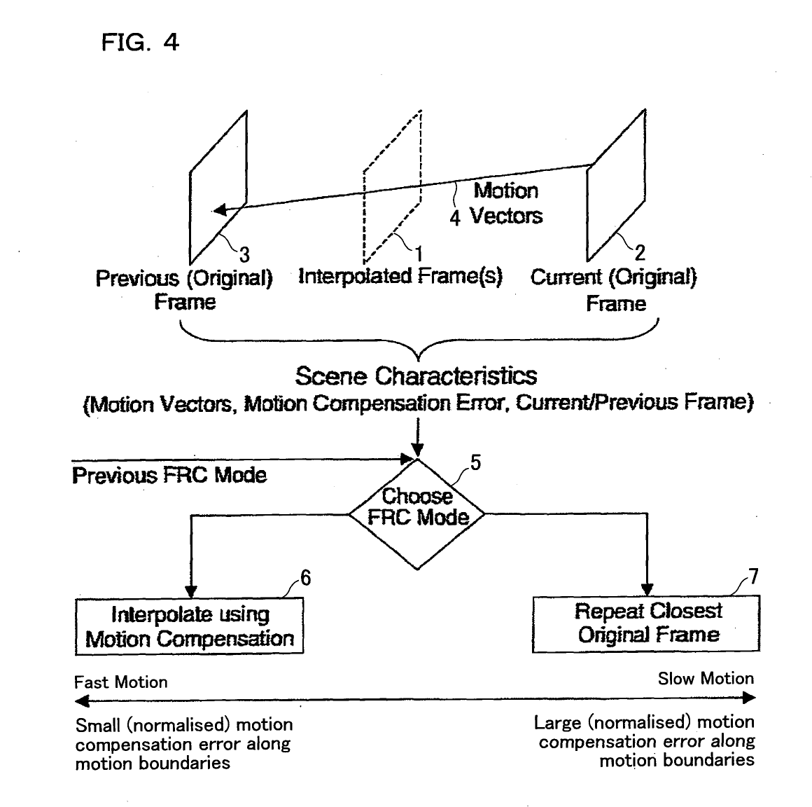

During the process of choosing the appropriate FRC mode (either frame repetition or motion compensated interpolation), a number of inputs are required. As shown in FIG. 4, the following parameters are necessary when determining the FRC mode: the motion vectors, the corresponding motion compensation error (SAD values), the current frame (or the previous frame), and the previous FRC mode.

By considering these inputs, the method determines at 5 the appropriate FRC mode. The faster the motion between the two original frames, the greater the probability of motion compensated interpolation 6 being used. However, the greater the motion compensation error along motion boundaries, the more likelihood there is that the interpolated frame will be replaced by either the current or previous frame (whichever is closer in time) 7.

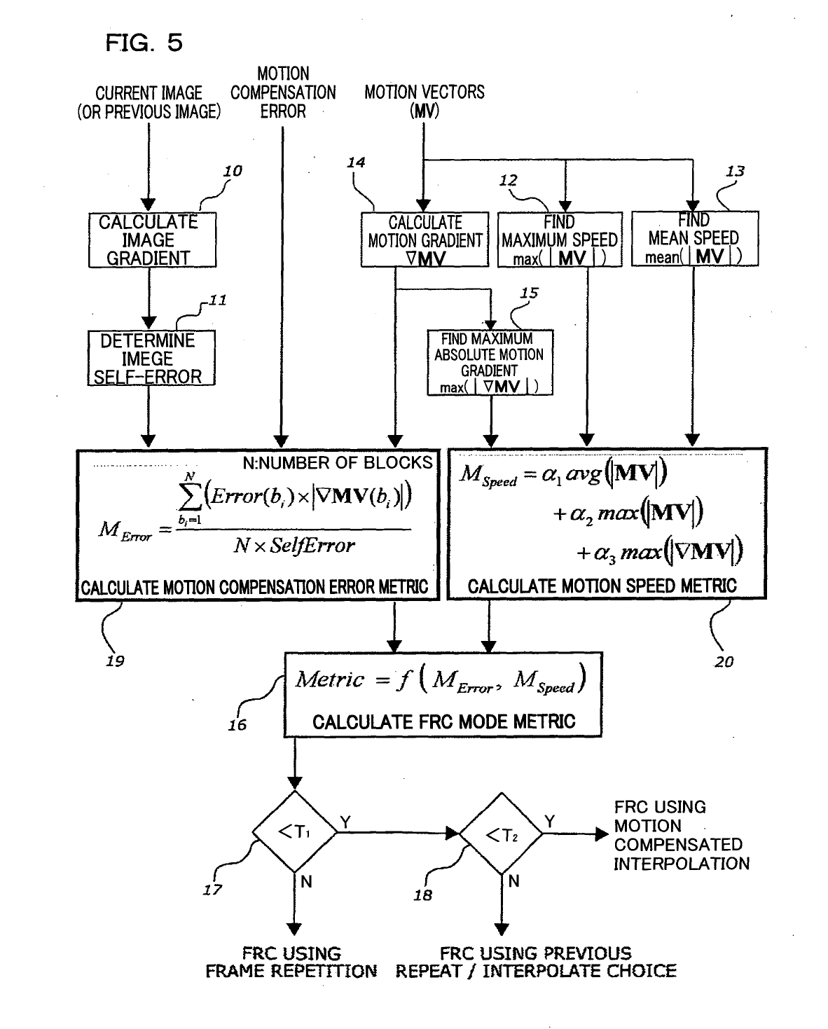

FIG. 5 illustrates in detail how the FRC metric is calculated and consequently how the appropriate FRC mode is determined. Several terms are used when calculating the metric, and these are discussed below in more detail:

### Image Gradient:

The image gradient is calculated at 10 in order to help normalise the motion compensation error (SAD), which is very sensitive to the texture and contrast characteristics of an image. The image gradient for the current frame is determined by first calculating the difference between each pixel and its neighbour (below and to the right).

### Image Self-Error:

The mean absolute value of these differences is then calculated at 11 in order to determine the “Self Error”. This “Self Error” is used as a normalising factor (for the motion compensation error) when calculating the FRC metric. Note that instead of using the current frame, the previous frame could also be used if required. The Self Error is calculated as:

$$SelfError = \frac{1}{( {N}_{R} - 1 ) ( {N}_{C} - 1 )} {\sum }_{r = 1}^{{N}_{R} - 1} {\sum }_{c = 1}^{{N}_{c} - 1} \vert {I}_{c} ( r , c ) - {I}_{c} ( r + 1 , c + 1 ) \vert$$

where I_{c} is the current frame, and N_{R} and N_{C} are (respectively) the number of rows and columns in I_{c}.

The self-error term provides a measure of image content, and more specifically a measure of image texture. The use of such a measure of image content helps to ensure that normalised error values are comparable across a wide range of video material.

### Motion Vectors:

As described above, the motion vectors, MV, are assumed to have been calculated during the motion estimation process and are used when determining the FRC mode metric. For each block, bᵢ, there is a corresponding motion vector, MV(bᵢ). There are a large variety of motion estimation methods [13], and in general these operate by matching corresponding regions/blocks in different frames.

### Motion Compensation Error:

As described above, the motion compensation error is assumed to have been calculated during the motion estimation process. A number of distortion metrics are commonly used to measure the motion compensation error associated with a particular motion vector. One popular method of calculating the error in a block-based system is to use the Sum of Absolute Differences (SAD) [13].

Consider a block bᵢ in interpolated frame F_{I} (which lies between original frames F_{P} and F_{C}). The distortion measure, SAD_{b}_{ᵢ}(u,v) is evaluated by comparing translated pixels in the current and previous frames, for all displacements (u,v) within some search radius:

$${SAD}_{{b}_{i}} ( u , v ) = {\sum }_{( x , y ) ∈ {b}_{i}} \vert {F}_{C} ( x - \frac{u}{2} , y - \frac{v}{2} ) - {F}_{P} ( x + \frac{u}{2} , y + \frac{v}{2} ) \vert$$

The motion vector, MV(bᵢ), is the displacement (u₀,v₀) that minimises the SAD distortion metric for block bᵢ.

$$MV ( {b}_{i} ) = {( {u}_{0} , {v}_{0} )}_{{b}_{i}} = {arg min}_{( u , v )} {SAD}_{{b}_{i}} ( u , v )$$

and block bᵢ's motion compensation error, Error(bᵢ), is the value of the SAD distortion metric corresponding to the motion vector, MV(bᵢ).

Error(bᵢ)=SAD_{b}_{ᵢ}(u₀,v₀)

### Speed of Motion:

The motion vectors are analysed in order to determine both the maximum speed, max(|MV|), at 12 and the average speed, avg(|MV|), at 13 between the current and previous frames.

### Motion Gradient:

The motion gradient is also calculated at 14, since this indicates motion boundaries within the scene. The equation below indicates how the absolute motion vector gradient, |∇MV|, is determined by considering the difference between the motion vector of a block and those of its eight closest neighbours. The absolute motion vector gradient has large values near motion boundaries and small values in regions of uniform motion.

$$\begin{matrix}\vert ∇ MV ( {b}_{i} ) \vert = \vert ∇ MV ( x , y ) \vert \\ = \frac{1}{8} {\sum }_{i = x - 1}^{i = x + 1} {\sum }_{j = y - 1}^{j = y + 1} ( ‖ \begin{matrix}MV ( x , y ) - \\ MV ( i , j )\end{matrix} ‖ )\end{matrix}$$

$$where ( x , y ) is the position of block {b}_{i}$$

### Maximum Absolute Motion Gradient:

In addition, the maximum absolute motion vector gradient, max(|∇MV|), is also evaluated at 15. This provides a useful way of measuring the maximum relative velocity between neighbouring blocks.

Using the above terms, it is possible to obtain useful measures of both the speed of motion and the degree of motion compensation error between a pair of original frames. The normalised motion compensation error metric, M_{Error} is calculated at 19 as:

$${M}_{Error} = \frac{{\sum }_{{b}_{i} = 1}^{N} ( Error ( {b}_{i} ) \times \vert ∇ MV ( {b}_{i} ) \vert )}{N \times SelfError}$$

The greater the normalised motion compensation error, the less effective motion compensated interpolation is likely to be—due to the increased visibility of motion compensation artefacts. As can be seen, M_{Error} is an increasing function of increasing motion compensation error and is proportional to an average of the product of the motion compensation error and the absolute value of the motion vector gradient for each of the image blocks. M_{Error} is also inversely proportional to the measure of image content, which provides normalising of the error metric. In a first embodiment, the value of M_{Error} may be used on its own as a metric for selecting between motion compensated interpolation and frame repetition.

The speed of motion metric is calculated at 20, with M_{Speed} defined as:

M_{Speed}=α₁avg(|MV|)+α₂max(|MV|)+α₃max(|∇MV|)

where α₁, α₂ and α₃ are weighting factors for the three motion terms. The faster the speed of motion (in relative or absolute terms), the greater the need for motion compensated interpolation when generating new frames in a sequence.

In a second embodiment, 1/M_{speed} may be used on its own as a metric for selecting between motion compensated interpolation and frame repetition. 1/M_{speed} is an increasing function of decreasing speed of motion and is inversely proportional to a linear combination of average speed of motion between frames, maximum speed of motion between frames and maximum absolute value of motion vector spatial gradient.

In a third embodiment, the metric used to determine the FRC mode (either frame repetition or frame interpolation) is calculated at 16 as a function of the above two metrics:

Metric=f(M_{Error},M_{Speed})

As described above, the metric can be a function of either normalised motion compensation error or the speed of motion but, for improved or optimal performance, the ratio of the two factors may be considered as follows:

$$Metric = \frac{{M}_{error}}{{M}_{Speed}}$$

Then expanding this in full gives:

$$Metric = \frac{{\sum }_{{b}_{i} = 1}^{N} ( Error ( {b}_{i} ) \times \vert ∇ MV ( {b}_{i} ) \vert )}{N \times SelfError \times ( \begin{matrix}\begin{matrix}{α}_{1} avg ( \vert MV \vert ) + \\ {α}_{2} max ( \vert MV \vert ) +\end{matrix} \\ {α}_{3} max ( \vert ∇ MV \vert )\end{matrix} )}$$

All of the above terms and factors are combined when calculating the FRC metric at 16. In the equation for the metric, the numerator is large when regions of large motion compensation error coincide with motion boundaries. A large value for the numerator indicates that the motion estimation process was probably unreliable.

On the other hand, the denominator provides a measure of the speed of absolute and relative motion within a scene (and also includes normalising factors). A large value for the denominator suggests that motion compensated interpolation is necessary when performing FRC, since there is likely to be a large degree of motion between consecutive original frames.

The resultant value of the FRC metric is then thresholded at 17 and 18 in order to determine the appropriate mode—frame repetition or motion compensated interpolation. The two thresholds, T₁ and T₂, are each non-negative real numbers, with T₁ (the first threshold) greater than or equal to T₂ (the second threshold). A high value for the metric (greater than or equal to a first threshold T₁) indicates that frame repetition should be used, while a low value for the metric (less than a second threshold T₂) results in motion compensated interpolation being selected. In the case of an intermediate value (between T₁ and T₂), the previous FRC mode is retained. This third option helps to prevent a potentially annoying change between modes.

Interpolated frames are generated by performing motion compensation from the surrounding original frames. Pixels in an interpolated frame are calculated by taking a weighted sum of (motion-compensated) pixel values from the neighbouring original frames. The motion compensation process may include techniques such as the use of overlapping blocks, de-blocking filters, and the handling of object occlusion and uncovering.

When the frame repetition mode is selected, then the interpolated frame should be replaced by the closer (in time) of the current and previous original frames.

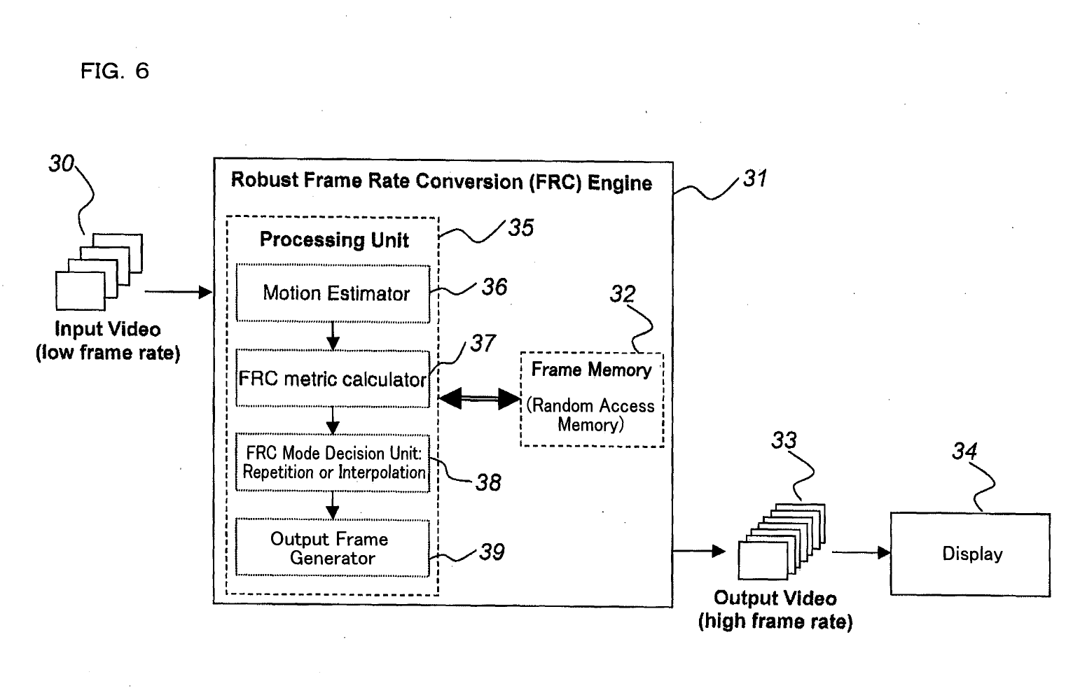

FIG. 6 illustrates an apparatus for performing this method. A video input line 30 supplies video signals at a relatively low frame rate to a robust FRC engine 31 including a processing unit 35 and frame memory 32 (for example a random access memory). The engine 31, which generally comprises some form of programmed computer, performs FRC and supplies video signals at a relatively high frame rate via an output line 33 to a display 34. The FRC engine's processing unit 35 comprises various stages including: a motion estimator 36, an FRC metric calculator 37, an FRC mode decision unit 38 (frame repetition or motion compensated interpolation), and an output frame generator 39. Each of these processing stages may access data in the frame memory as required.

As described above, the FRC mode is determined by thresholding the metric:

$$Metric = \frac{{\sum }_{{b}_{i} = 1}^{N} ( Error ( {b}_{i} ) \times \vert ∇ MV ( {b}_{i} ) \vert )}{N \times SelfError \times ( \begin{matrix}\begin{matrix}{α}_{1} avg ( \vert MV \vert ) + \\ {α}_{2} max ( \vert MV \vert ) +\end{matrix} \\ {α}_{3} max ( \vert ∇ MV \vert )\end{matrix} )}$$

The weighting factors for the three speed-related terms in the denominator are the scalars α₁, α₂ and α₃. Typically α₁ has the largest value of the three and, based on empirical testing, the following values have been used: α₁=2, α₂=0.5, and α₃=0.5.

When thresholding the metric to determine the appropriate FRC mode, the thresholds T₁ and T₂ are chosen in order to maximise the portrayal of smooth, artifact-free motion. Both thresholds are required to be non-negative and T₁ should be greater than or equal to T₂. Following testing over a variety of sequences, suitable values for Tᵢ and T₂ are 0.03 and 0.02, respectively. Reducing the thresholds increases the likelihood of frame repetition, while increasing them can result in motion compensation errors becoming more noticeable for some video sequences.

For a fuller understanding of the nature and advantages of the invention, reference should be made to the ensuing detailed description taken in conjunction with the accompanying drawings.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A method of performing frame rate conversion to a higher frame rate, comprising: forming a metric as a function of motion compensation error normalised by a measure of image content; and selecting between a motion compensated interpolation mode and a frame repetition mode in accordance with the value of the metric.

2. A method as claimed in claim 1, in which the function is an increasing function of increasing motion compensation error.

3. A method as claimed in claim 2, in which the metric is proportional to an average of the product of the motion compensation error and the absolute value of the motion vector gradient for each of a plurality of image blocks.

4. A method as claimed in claim 2, in which the metric is inversely proportional to the measure of image content.

5. A method as claimed in claim 1, in which the metric is also a function of at least one of average speed of motion between frames, maximum speed of motion between frames and maximum absolute value of motion vector spatial gradient.

6. A method as claimed in claim 2, in which the metric is also a function of at least one of average speed of motion between frames, maximum speed of motion between frames and maximum absolute value of motion vector spatial gradient, and in which the metric is inversely proportional to a linear combination of the average speed of motion, the maximum speed of motion and the maximum absolute value of the motion vector gradient.

7. A method as claimed in claim 2, in which the frame repetition mode is selected if the metric is greater than a first threshold.

8. A method as claimed in claim 2, in which the motion compensated interpolation mode is selected if the metric is less than a second threshold.

9. A method as claimed in claim 7, in which the motion compensated interpolation mode is selected if the metric is less than a second threshold, and in which the first threshold is greater than the second threshold and the previously selected mode is selected if the metric is between the first and second thresholds.

10. A method as claimed in claim 1, in which the measure of image content is a measure of image texture.

11. A method as claimed in claim 10, in which the measure of image texture comprises an average absolute value of an image spatial gradient.

12. A method of performing frame rate conversion to a higher frame rate, comprising: forming a metric as a function of speed of motion between consecutive frames; and selecting between a motion compensated interpolation mode and a frame repetition mode in accordance with the value of the metric.

13. A method as claimed in claim 12, in which the function is an increasing function of decreasing speed of motion.

14. A method as claimed in claim 13, in which the metric is inversely proportional to a linear combination of average speed of motion between frames, maximum speed of motion between frames and maximum absolute value of motion vector spatial gradient.

15. A method as claimed in claim 12, in which the frame repetition mode is selected if the metric is greater than a first threshold.

16. A method as claimed in claim 12, in which the motion compensated interpolation mode is selected if the metric is less than a second threshold.

17. A method as claimed in claim 15, in which the motion compensated interpolation mode is selected if the metric is less than a second threshold, and in which the first threshold is greater than the second threshold and the previously selected mode is selected if the metric is between the first and second thresholds.

18. A method as claimed in claim 12, in which the metric is inversely proportional to a measure of image content.

19. A method as claimed in claim 18, in which the measure of image content is a measure of image texture.

20. A method as claimed in claim 19, in which the measure of image texture comprises an average absolute value of an image spatial gradient.

21. An apparatus for performing a method as claimed in claim 12.

22. An apparatus for performing a method as claimed in claim 1.
